(19) United States
(12) Patent Application Publication
(10) Pub. No.: US 2026/0104067 A1
(43) Pub. Date: Apr. 16, 2026

(54) COUPLED BODY, POWDER COMPACT, AND METHOD OF MANUFACTURING POWDER COMPACT

(71) Applicant: SUMITOMO ELECTRIC SINTERED ALLOY, LTD., Takahashi-shi (JP)

(72) Inventors: Masaaki EIDA, Takahashi-shi (JP); Tatsuya SAITO, Takahashi-shi (JP); Yuki HIRAO, Takahashi-shi (JP)

(73) Assignee: SUMITOMO ELECTRIC SINTERED ALLOY, LTD., Takahashi-shi (JP)

(21) Appl. No.: 19/353,649

(22) Filed: Oct. 9, 2025

(30) Foreign Application Priority Data
Oct. 15, 2024 (JP) 2024-179780

(51) Int. Cl. F16B 5/02; H01F 1/047; H01F 1/06; H02K 1/02; H02K 1/18

(52) U.S. Cl. CPC F16B 5/02; H01F 1/047; H01F 1/06; H02K 1/02; H02K 1/18

(57) ABSTRACT

A coupled body includes a first member, a second member disposed in contact with the first member, and a screw configured to couple the first member and the second member to each other by passing through the first member and reaching the second member. At least one of the first member and the second member is a powder compact. The powder compact has a first surface facing the first member in contact with the powder compact or facing a head portion of the screw, a recessed portion formed on the first surface, and a first hole extending from the recessed portion and in which a shaft portion of the screw is disposed. An opening area of the recessed portion is larger than an opening area of the first hole. An inner circumferential surface of the recessed portion has no machining mark.

### CROSS-REFERENCE TO RELATED APPLICATION

This application claims priority based on Japanese Patent Application No. 2024-179780 filed on Oct. 15, 2024, and the entire contents of the Japanese patent application are incorporated herein by reference.

### TECHNICAL FIELD

The present disclosure relates to a coupled body, a powder compact, and a method of manufacturing a powder compact.

### BACKGROUND

In recent years, it has been attempted to couple a powder compact manufactured by pressure-compacting a powder to another member by a self-tapping screw. As such a technique, Patent Literature (WO 2020/226011) discloses a coupled body in which a first member and a second member independent of each other are coupled by a self-tapping screw. At least one of the first member and the second member in the coupled body is a powder compact.

### SUMMARY

A coupled body of the present disclosure includes a first member, a second member disposed in contact with the first member, and a screw configured to couple the first member and the second member to each other by passing through the first member and reaching the second member. At least one of the first member and the second member is a powder compact. The powder compact has a first surface facing the first member in contact with the powder compact or facing a head portion of the screw, a recessed portion formed on the first surface, and a first hole extending from the recessed portion and in which a shaft portion of the screw is disposed. An opening area of the recessed portion is larger than an opening area of the first hole. An inner circumferential surface of the recessed portion has no machining mark.

### BRIEF DESCRIPTION OF THE DRAWINGS

FIG. 1 is a schematic configuration diagram of a coupled body according to embodiment 1.

FIG. 2 is a partially enlarged diagram of FIG. 1.

FIG. 3 is an explanatory diagram for explaining a procedure for manufacturing a powder compact included in the coupled body according to embodiment 1.

FIG. 4 is a partially enlarged cross-sectional diagram of the powder compact manufactured by the metal mold shown in FIG. 3.

FIG. 5 is a schematic configuration diagram of a coupled body according to embodiment 2.

FIG. 6 is a schematic configuration diagram of a coupled body according to embodiment 3.

FIG. 7 is a schematic configuration diagram of a coupled body according to embodiment 4.

FIG. 8 is a schematic configuration diagram of a coupled body according to embodiment 5.

FIG. 9 is a schematic configuration diagram of a rotating electrical machine according to embodiment 6.

FIG. 10 is a schematic configuration diagram showing a portion of a rotating electrical machine according to embodiment 7.

FIG. 11 is a schematic configuration diagram showing a portion of a rotating electrical machine according to embodiment 8.

### DETAILED DESCRIPTION

When the self-tapping screw is screwed into the pilot hole formed in the powder compact, the self-tapping screw forms a screw groove on the inner circumferential surface of the pilot hole. When the self-tapping screw processes the pilot hole, a burr is generated. The burr protrudes from the opening portion of the pilot hole. Here, when the powder compact and another member are overlapped and the self-tapping screw is screwed from the another member toward the powder compact, the burr is sandwiched between the powder compact and the another member, and a gap is likely to be formed between the powder compact and the another member. In addition, when the powder compact and another member are stacked and the self-tapping screw is screwed from the powder compact toward the another member, the burr is sandwiched between the head portion of the self-tapping screw and the powder compact, and a gap is likely to be formed between the head portion and the powder compact. In any case, the burr may cause the connection between the powder compact and the another member to be unstable.

An object of the present disclosure is to provide a coupled body in which a first member and a second member are stably coupled to each other even when at least one of the first member and the second member coupled by a screw is a powder compact.

### Description of Embodiments of Present Disclosure

In the process of studying the above problems, the present inventors have conceived of forming a recessed portion in an opening portion of a pilot hole in which a self-tapping screw is disposed in a powder compact. In this case, even when the self-tapping screw is screwed into the pilot hole and the burr protrudes to the opening portion of the pilot hole, the burr is housed in the recessed portion. However, since the powder compact is brittle, when the recessed portion is formed by cutting or the like, the edge of the opening portion of the recessed portion is easily chipped. In addition, the labor for performing the cutting process reduces the productivity of the powder compact. Based on these findings, the present inventors have completed the constitution of the present disclosure. The embodiments of the present disclosure are listed below.
<1> A coupled body of the present disclosure includes a first member, a second member disposed in contact with the first member, and a screw configured to couple the first member and the second member to each other by passing through the first member and reaching the second member. At least one of the first member and the second member is a powder compact. The powder compact has a first surface facing the first member in contact with the powder compact or facing a head portion of the screw, a recessed portion formed on the first surface, and a first hole extending from the recessed portion and in which a shaft portion of the screw is disposed. An opening area of the recessed portion is larger than an opening area of the first hole. An inner circumferential surface of the recessed portion has no machining mark.

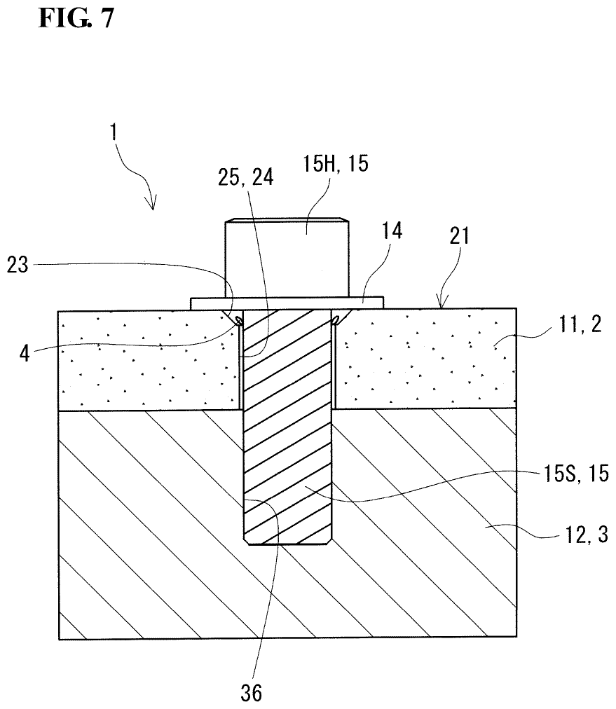

The first hole formed in the powder compact in the coupled body is a screw hole to which a screw is screw-coupled or a through-hole through which a screw passes through. In this specification, a hole formed in the powder compact before being incorporated into the coupled body, in which the shaft portion of the screw is disposed when the coupled body is manufactured, is referred to as a base hole. An internal thread portion for screw-coupling of the screw is not formed on the inner circumferential surface of the base hole. When the self-tapping screw is screwed into the base hole during the manufacture of the coupled body, that is, when the base hole functions as a pilot hole, the inner circumferential surface of the base hole is screw-processed by the self-tapping screw, and the internal thread portion is formed on the inner circumferential surface of the base hole. In this case, the base hole in which the internal thread portion is formed at the time of manufacturing the coupled body becomes the first hole in the coupled body. Here, as shown in embodiment 4 with reference to FIG. 7, there may be a case where the screw coupling the first member and the second member is not a self-tapping screw. In this case, the inner diameter of the base hole is made larger than the outer diameter of the screw. Since the shaft portion of the screw is simply inserted into the base hole without screw-processing the base hole at the time of manufacturing the coupled body, the base hole of the powder compact becomes the first hole of the coupled body as it is. In the following description, the coupling of the first member and the second member by the self-tapping screw will be mainly described.

In the coupled body of the above <1>, a screw is attached from the first member toward the second member. When the first member is a powder compact, the recessed portion of the first member faces the head portion of the screw. When the screw coupling the first member and the second member is a self-tapping screw, the burr generated by the screw-processing of the base hole is housed in a space surrounded by the recessed portion of the first member and the head portion of the screw. Thus, the burr is kept from being caught between the first member and the head portion of the screw, and the first member and the second member are firmly coupled.

When the second member is a powder compact, the recessed portion of the second member faces the first member. When the screw coupling the first member and the second member is a self-tapping screw, the burr generated by the screw-processing of the base hole is housed in a space surrounded by the recessed portion of the second member and the first member. Thus, the burr is kept from being sandwiched between the first member and the second member, and the first member and the second member are firmly coupled.

The inner circumferential surface of the recessed portion in the coupled body has no machining mark. The machining mark is also called a tool mark, and has a characteristic appearance, and thus, can be visually distinguished. Thus, the absence of the machining mark on the inner circumferential surface of the recessed portion can be confirmed by visually observing the inner circumferential surface of the recessed portion. The fact that the inner circumferential surface of the recessed portion does not have a machining mark means that the recessed portion is not formed by cutting but is formed during the pressure-compacting of the powder compact. That is, when the inner circumferential surface of the recessed portion is visually observed, it can be seen that the inner circumferential surface of the recessed portion is not a cut face formed by cutting but a compression molded face to which the shape of the metal mold is transferred. When the recessed portion is formed by pressure-compacting, chipping or the like is less likely to occur in the recessed portion. If there is no chip in the recessed portion, when the first member and the second member are coupled, a defect such as a crack of the powder compact starting from the chip is less likely to occur.
<2> In the coupled body according to the above <1>, the second member may be the powder compact. A surface of the second member facing the first member may be the first surface.

In the configuration of the above <2>, the burr generated by the screw-processing of the base hole by the self-tapping screw is disposed in the space surrounded by the recessed portion of the second member and the first member. Thus, the burr is not easily caught between the first member and the second member, and a gap is not easily formed between the first member and the second member.
<3> In the coupled body according to the above <1> or <2>, the screw may be a self-tapping screw.

The self-tapping screw is firmly fixed to the powder compact while screw-processing the base hole formed in the powder compact. Thus, the coupling between the first member and the second member by the self-tapping screw becomes strong. In addition, it is not necessary to form an internal thread portion in the base hole of the powder compact before coupling the first member and the second member, and thus the productivity of the coupled body is improved.
<4> In the coupled body according to any one of the above <1> to <3>, relative density of the powder compact may be 85% or more.

When the relative density of the powder compact is 85% or more, the powder compact is less likely to be cracked or chipped during the manufacture of the coupled body. In particular, even when the first member and the second member are coupled by the self-tapping screw, the powder compact is less likely to be cracked or chipped by the self-tapping screw.
<5> In the coupled body according to any one of the above <1> to <4>, the powder compact may contain soft magnetic powder. The soft magnetic powder may be an aggregate of soft magnetic particles each having insulation coating on a surface thereof. The soft magnetic particles may be made of at least one material selected from the group consisting of pure iron, an Fe—Si—Al-based alloy, an Fe—Si-based alloy, an Fe—Al-based alloy, and an Fe—Ni-based alloy.

The powder compact including the soft magnetic powder is used for, for example, a core of a rotating electrical machine or a reactor. Since the powder compact containing the soft magnetic powder has sufficient strength, even when the powder compact and another member are coupled by a screw, the powder compact is less likely to be cracked or chipped.
<6> In the coupled body according to any one of the above <1> to <5>, the inner circumferential surface of the recessed portion may include an inclined surface connected to the first surface. An angle formed by the first surface and an extension surface may be less than 90 degrees, the extension surface being an extension of the inclined surface extended further outward than the first surface.

The recessed portion having the inclined surface is a recessed portion having a shape gradually widened from the opening portion of the first hole toward the opening portion of the recessed portion along the axis of the first hole. When the formed angle between the extension surface of the inclined surface and the first surface is less than 90 degrees, it is easy to pull out a metal mold for forming the recessed portion when manufacturing the powder compact.
<7> In the coupled body according to any one of the above <1> to <6>, the recessed portion may have a depth of 0.1 mm to 3.0 mm.

The depth of the recessed portion is a distance from the first surface to the deepest portion of the recessed portion. When the depth of the recessed portion is 0.1 mm or more, it is easy to house the burr generated by screw-processing the base hole of the powder compact in the recessed portion. When the depth of the recessed portion is 3.0 mm or less, the substantial portion of the powder compact is not excessively reduced by the recessed portion. In addition, when the depth of the recessed portion is 3.0 mm or less, the strength of the portion corresponding to the recessed portion in the metal mold for forming the powder compact is less likely to decrease.
<8> In the coupled body according to any one of <1> to <7>, the inner circumferential surface of the recessed portion may include a bottom surface parallel to the first surface.

When the recessed portion has a bottom surface parallel to the first surface, the screw is less likely to be inclined when the first member and the second member are coupled by the screw. Unlike the configuration of the above <8>, if the recessed portion is configured only by the inclined surface, when the first member and the second member are coupled by the screw, the screw may be guided by the inclined surface and the screw may be inclined.
<9> In the coupled body according to any one of <1> to <8>, the second member may be a core of a stator of a rotating electrical machine. The first member may be a case configured to house the stator. The core may be formed by the powder compact.

With the above configuration the above <9>, the stator can be firmly fixed to the case. Since the stator is less likely to move with respect to the case, the operation of the rotating electrical machine is stabilized.
<10> In the coupled body according to any one of <1> to <8>, the second member may be a tooth included in a core of a stator of a rotating electrical machine. The first member may be a yoke included in the core. The tooth may be formed by the powder compact.

The yoke is disposed on an end surface of the tooth opposite to an end surface facing a rotor of the rotating electrical machine. In the configuration of the above <10>, since the tooth and the yoke are independently produced, the tooth and the yoke can be produced more easily than when a member having a complicated shape in which the tooth and the yoke are integrated is produced.
<11> In the coupled body according to any one of the above <1> to <8>, the second member may be a tooth included in a core of a stator of a rotating electrical machine. The first member may be a pole shoe member disposed at an end surface of the tooth. The tooth may be formed by the powder compact.

The pole shoe member is disposed on an end surface of the tooth facing the rotor. In the above configuration the above <11>, since the tooth and the pole shoe member are independently produced, the tooth and the pole shoe member can be produced more easily than in the case of producing a member having a complicated shape in which the tooth and the pole shoe portion are integrated.
<12> A powder compact of the present disclosure is a powder compact configured to be coupled to another member by a screw, and the powder compact includes a first surface configured to face the another member or a head portion of the screw in a state in which the powder compact is coupled to the another member, and a recessed portion formed on the first surface. The powder compact has a base hole extending from the recessed portion and configured such that a shaft portion of the screw is disposed in the base hole in a state in which the powder compact is coupled to the another member. An opening area of the recessed portion is larger than an opening area of the base hole. An inner circumferential surface of the recessed portion has no machining mark.

The powder compact of the present disclosure is one of the constituent materials of the coupled body of the present disclosure. The powder compact of the present disclosure can be a first member or a second member in the coupled body of the present disclosure. In addition, the base hole of the powder compact of the present disclosure is a first hole in which a screw is disposed in the coupled body of the present disclosure.
<13> A method of manufacturing a powder compact of the present disclosure includes: forming the recessed portion of the powder compact described in the above <12> by compacting by which the powder compact is manufactured.

Unlike the configuration of the above <13>, when the recessed portion is formed by cutting, the edge of the opening portion of the recessed portion may be chipped due to tensile stress during cutting. On the other hand, in the configuration of the above <13> in which the recessed portion of the powder compact is formed by compacting, chipping is less likely to occur at the edge of the opening portion of the recessed portion.

In addition, by forming the recessed portion of the powder compact by compacting, the number of production processes of the powder compact can be reduced as compared with the case where the recessed portion is formed by cutting. Thus, the productivity of the coupled body including the powder compact is improved.
<14> The method of manufacturing a powder compact described in the above <13> may include: forming the base hole by drilling after the compacting.

When the base hole of the powder compact is formed by compacting, there is a concern that the density of the powder compact in the vicinity of the base hole may vary. In addition, the number of parts of the metal mold increases by the number of cores corresponding to the base holes. When the inner diameter of the base hole is small, the strength of the core corresponding to the base hole is likely to decrease, and the core may be damaged during compacting. On the other hand, in the configuration of the above <14> in which the base hole is formed by drilling, the density of the entirety of the powder compact is likely to be uniform. Here, since the base hole is formed from the position of the recessed portion, the burr generated by drilling is housed in the recessed portion. Thus, burrs generated by drilling do not cause a problem in manufacturing a coupled body.
<15> The method of manufacturing a powder compact described in the above <14> may include: forming a thickened portion protruding from a bottom surface of the recessed portion by the compacting; and removing an entirety of the thickened portion by the drilling.

By forming the thickened portion protruding from the bottom surface of the recessed portion during the compacting of the powder compact, a difference in molding pressure is less likely to occur between a portion having the recessed portion and a portion other than the recessed portion, and thus the density of the entirety of the powder compact is more likely to be uniform.

### Details of Embodiments of Present Disclosure

Hereinafter, specific examples of the coupled body, the powder compact, and the method of manufacturing the powder compact of the present disclosure will be described with reference to the drawings. The same reference numerals in the drawings denote the same or corresponding parts. The size of the member shown in each figure face is expressed for the purpose of clarifying the description, and does not necessarily represent the actual dimension. The present invention is not limited to these examples, but is defined by the scope of the claims, and is intended to include all modifications within the meaning and scope equivalent to the scope of the claims.

### Embodiment 1

### Entirety of Configuration

A coupled body 1 of the present example includes a first member 11, a second member 12 disposed in contact with the first member 11, and a self-tapping screw 13 configured to couple the first member 11 and the second member 12 to each other. The self-tapping screw 13 passes through the first member 11, reaches the second member 12, and is screw-coupled to the second member 12. In this example, the second member 12 is a powder compact 2, and the first member 11 is a non-powder-compact body 3. One of the features of the coupled body 1 of the present example is the configuration of the powder compact 2. Hereinafter, each configuration of the coupled body 1 of the present example will be described in detail.

### Self-Tapping Screw

The self-tapping screw 13 includes a shaft portion 13S and a head portion 13H. A male screw portion is formed on the outer periphery of the shaft portion 13S. The head portion 13H may include a tool hole for inserting a driver or the like. The type of the self-tapping screw 13 is not particularly limited. For example, the self-tapping screw 13 may be of a B-0 type or a B-1 type. The self-tapping screw 13 of the B-1 type is the self-tapping screw 13 having a groove serving as a cutting edge formed at the front end thereof.

In the coupled body 1 of this example, a washer 14, which is a member different from the self-tapping screw 13, is disposed between the head portion 13H and the first member 11. The self-tapping screw 13 in which the washer 14 is integrated with the head portion 13H may be used. In this case, the head portion 13H contacts the first member 11.

### Powder Compact

The powder compact 2, which forms the second member 12, contains, for example, soft magnetic powder. The soft magnetic powder is an aggregate of soft magnetic particles. The soft magnetic particles are made of, for example, at least one material selected from the group consisting of pure iron, an Fe (iron)-Si (silicon)-Al (aluminum)-based alloy, an Fe—Si-based alloy, an Fe—Al-based alloy, and an Fe—Ni (nickel)-based alloy. The soft magnetic particles may have an insulation coating on the surface thereof. Since the insulation coating is formed on the surface of the soft magnetic particles, the soft magnetic particles are electrically insulated from each other. When the powder compact 2 is used for a core of a rotating electrical machine or the like, the eddy current loss of the core can be reduced by the insulation coating. The insulation coating is, for example, a phosphate coating or a silica coating.

The average particle diameter of the soft magnetic particles is, for example, 10 μm to 400 μm. When the average particle diameter of the soft magnetic particles is 10 μm or more, an increase in hysteresis loss in the powder compact 2 can be reduced in the case of using the powder compact 2 for a core of a rotating electrical machine or the like. When the average particle diameter of the soft magnetic particles is 400 μm or less, the eddy current loss of the powder compact 2 generated in a high frequency region is reduced in the case of using the powder compact 2 for a core of a rotating electrical machine or the like. The average particle diameter of the soft magnetic particles may be, for example, 10 μm to 300 μm, or 40 μm to 260 μm. Here, the term “average particle diameter” means that a particle diameter of particles in which the sum of the mass of particles having a smaller particle diameter reaches 50% of the total mass in the histogram of the particle diameter, that is, a 50% particle diameter.

The relative density of the powder compact 2 is desirably 85% or more. When the density of the powder compact is increased, the powder compact 2 is less likely to be cracked or chipped. The relative density of the powder compact 2 may be 90% or more, 93% or more, or 95% or more. The relative density of the powder compact 2 is a value obtained by dividing the apparent density of the powder compact 2 by the true density. The apparent density is determined by measuring the volume of the powder compact 2 by the Archimedes method and dividing the mass of the powder compact 2 by the measured volume.

The powder compact 2 includes a first surface 21, a recessed portion 23, and a first hole 25. The first surface 21 in this example is a face facing the first member 11. The recessed portion 23 is a recess formed on the first surface 21. The first hole 25 is a blind hole extending from the recessed portion 23. The shaft portion 13S of the self-tapping screw 13 is disposed in the first hole 25. The first hole 25 may be a through-hole that opens to the first surface 21 and a second surface 22. The second surface 22 is a face on the opposite side of the first surface 21.

The shaft portion 13S of the self-tapping screw 13 is screw-coupled to the first hole 25. The first hole 25 is formed by screwing the self-tapping screw 13 into a base hole 24 formed in advance in the powder compact 2. The base hole 24 of the present example is generally called a pilot hole. The base hole 24 has an inner circumferential surface formed of a cylindrical face. The base hole 24 is screw-processed by the self-tapping screw 13, thereby forming an internal thread portion 24f. The base hole 24 provided with the internal thread portion 24f is the first hole 25.

A gap is formed between the bottom surface of the first hole 25 and the front end of the shaft portion 13S. Thus, the front end of the shaft portion 13S does not apply stress to the bottom surface of the first hole 25, and the powder compact 2 is less likely to crack.

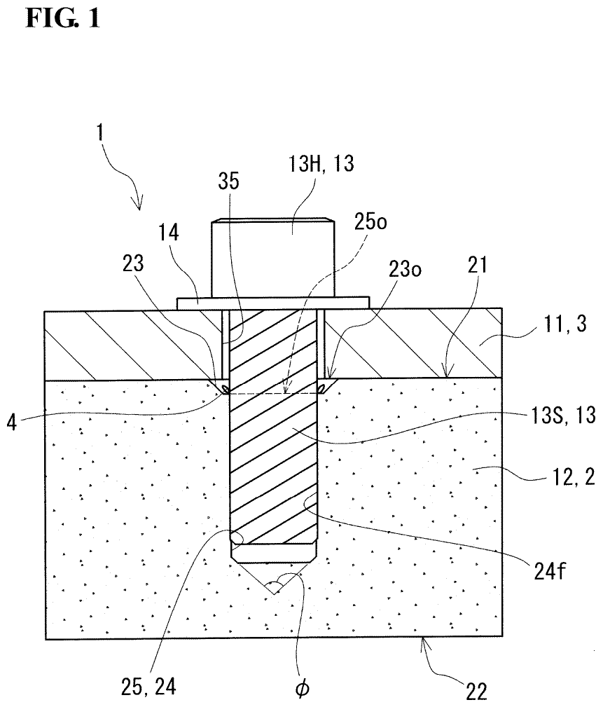

The bottom of the first hole 25 may be tapered as shown in FIG. 1. In this case, the front end of the shaft portion 13S of the self-tapping screw 13 is less likely to come into contact with the bottom surface of the first hole 25, and even when the front end of the shaft portion 13S comes into contact with the bottom surface of the first hole 25, the powder compact 2 is less likely to crack. A formed angle φ of the tapered shape of the bottom portion is, for example, 85 degrees to 145 degrees. The formed angle φ is an angle between a left inclined surface and a right inclined surface of the bottom portion sandwiching the axis in the cut face including the axis of the shaft portion 13S.

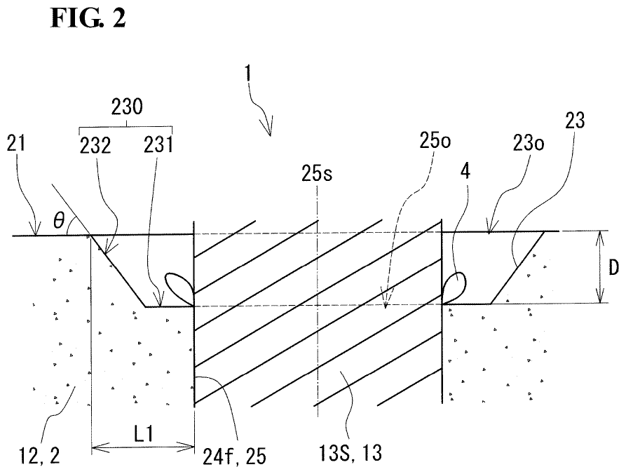

As shown in FIG. 2, the recessed portion 23 is formed to surround an opening portion 25o of the first hole 25. The opening area of the recessed portion 23 is larger than the opening area of the first hole 25. That is, the opening portion 25o of the first hole 25 is disposed inside an opening portion 23o of the recessed portion 23 in a top view.

The opening portion 23o of the recessed portion 23 has a size that fits inside the outer peripheral contour line of the washer 14 (FIG. 1) in a top view, for example. In that case, the washer 14 does not fall into the recessed portion 23. When the washer 14 is not used in the coupled body 1, the opening portion 23o has a size that fits inside the outer peripheral contour line of the head portion 13H of the self-tapping screw 13, for example.

An inner circumferential surface 230 of the recessed portion 23 is a compression molded face without machining marks. It can be confirmed by visual observation that the inner circumferential surface 230 does not have a machining mark. The recessed portion 23 may be formed by the pressure-compacting, as described below. The opening portion 23o of the recessed portion 23 formed without using cutting has no chipping caused by cutting. In addition, since the recessed portion 23 is formed without cutting, the productivity of the powder compact 2 is high.

An arithmetic average roughness Ra of the inner circumferential surface 230 of the recessed portion 23 is, for example, 3.2 μm or less. The arithmetic average roughness Ra is based on JIS B 0601:2013. When the recessed portion 23 is formed by cutting, the arithmetic average roughness Ra of the inner circumferential surface 230 of the recessed portion 23 tends to be more than 3.2 μm. That is, the arithmetic average roughness Ra of the inner circumferential surface 230 being 3.2 μm or less is one of the indicators that the recessed portion 23 is formed by the pressure-compacting.

The inner circumferential surface 230 of the recessed portion 23 of the present example includes a bottom surface 231 parallel to the first surface 21 and an inclined surface 232 connecting the first surface 21 and the bottom surface 231. The inclined surface 232 is inclined so as to be gradually separated from an axis 25s as it goes from the first hole 25 toward the first surface 21 along the axis 25s of the first hole 25.

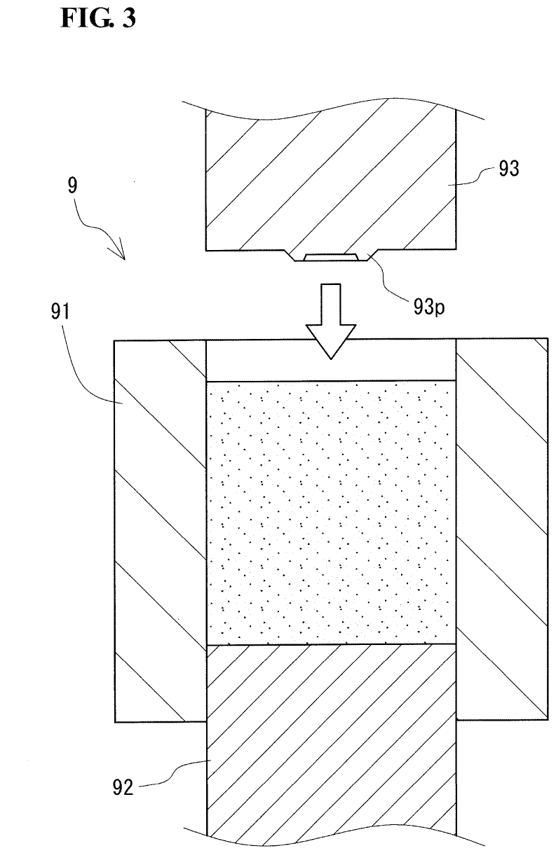

The bottom surface 231 is a configuration for making the axis of the self-tapping screw 13 less likely to be inclined when the self-tapping screw 13 is screwed, as described in the method of manufacturing the coupled body 1 described later. The inclined surface 232 is a configuration for facilitating the pulling out of the powder compact 2 from a mold 9 (see FIG. 3) when the recessed portion 23 is formed by compacting, as described in the method of manufacturing the powder compact 2 described later. A formed angle θ between an extension surface obtained by extending the inclined surface 232 and the first surface 21 is less than 90 degrees. As the formed angle θ decreases, the powder compact 2 is more easily pulled out from the mold 9. The formed angle θ may be, for example, 80 degrees or less, or 70 degrees or less. Regarding the lower limit of the formed angle θ, the formed angle θ may be, for example, 30 degrees or more, or may be 45 degrees or more. The formed angle θ in this example is 70 degrees.

Unlike the present example, the inner wall face of the recessed portion 23 may be a wall face perpendicular to the bottom surface 231. In this case, the formed angle θ between the extension surface extended from the wall face and the first surface 21 is 90 degrees.

As described above, when the self-tapping screw 13 is screwed into the base hole 24, the self-tapping screw 13 bites into the inner circumferential surface of the base hole 24, and a portion of the inner circumferential surface is shaved off. The shavings protrude from the opening portion 25o of the first hole 25 as a burr 4. In this example, since the recessed portion 23 is formed so as to surround the opening portion 25o, the burr 4 is disposed in the recessed portion 23. The burr 4 disposed in the recessed portion 23 is not sandwiched between the first member 11 and the second member 12 as shown in FIG. 1. Thus, the first member 11 and the second member 12 can be firmly coupled to each other without forming a large gap between the first member 11 and the second member 12. The first member 11 and the second member 12 which are firmly coupled to each other are hardly uncoupled from each other, and the coupled state is maintained for a long period of time.

A depth D of the recessed portion 23 in which the burr 4 is housed is, for example, 0.1 mm to 3.0 mm. The depth D of the recessed portion 23 having the bottom surface 231 is the distance from the first surface 21 to the deepest position of the recessed portion 23, that is, the distance from the first surface 21 to the bottom surface 231 in this example. When the depth D of the recessed portion 23 is 0.1 mm or more, the burr 4 is easily housed in the recessed portion 23. When the depth D of the recessed portion 23 is 3.0 mm or less, the substantial portion of the powder compact 2 is not excessively reduced. The strength of the portion corresponding to the recessed portion 23 in the mold 9 (see FIG. 3) for forming the powder compact 2 is less likely to decrease. The depth D of the recessed portion 23 may be, for example, 0.3 mm to 1.0 mm.

A length L1 from the edge of the first hole 25 to the edge of the opening portion 23o of the recessed portion 23 is, for example, 0.2 mm to 3.0 mm. When the length L1 is 0.2 mm or more, the self-tapping screw 13 is easily inserted into the base hole 24 at the time of manufacturing the coupled body 1. When the length L1 is 3.0 mm or less, the recessed portion 23 is not too large, and the first member 11 and the second member 12 have a sufficient contact face area, so that the coupling between the first member 11 and the second member 12 is likely to be stable. Here, the smaller the formed angle θ, the longer the length L1. Thus, the upper limit of the length L1 can be regarded as defining the lower limit of the formed angle θ. When the formed angle θ is equal to or more than the above-described lower limit value, not only the powder compact 2 is easily pulled out from the mold 9, but also the length L1 does not become too large even when the depth D of the recessed portion 23 is increased.

### Non-Powder-Compact Body

The non-powder-compact body 3, which forms the first member 11, may be anything other than the powder compact 2. For example, the non-powder-compact body 3 may be made of metal or resin. The non-powder-compact body 3 includes a through-hole 35 through which the shaft portion 13S of the self-tapping screw 13 is inserted. The inner diameter of the through-hole 35 is larger than the inner diameter of the shaft portion 13S. That is, the through-hole 35 is a through-hole through which the self-tapping screw 13 passes. The through-hole 35 of the present example does not have an internal thread portion on the inner circumferential surface of the through-hole 35, but has an inner circumferential surface formed of a cylindrical face. Unlike the present example, the through-hole 35 may be a screw hole having an internal thread portion on the inner circumferential surface of the through-hole 35. In this case, a portion of the shaft portion 13S is screw-coupled to the through-hole 35.

### Method of Manufacturing Powder Compact

The powder compact 2, which forms the second member 12, is manufactured by compacting using the mold 9 shown in FIG. 3. The mold 9 includes a die 91, a lower punch 92, and an upper punch 93. When the powder compact 2 is manufactured by the mold 9, first, the lower punch 92 is fitted into the die 91. A cavity surrounded by the inner circumferential surface of the die 91 and the upper face of the lower punch 92 is filled with soft magnetic powder. Finally, the upper punch 93 is fitted into the die 91 from above the die 91, the upper punch 93 is moved downward, and the soft magnetic powder is compressed between the lower punch 92 and the upper punch 93. The compression direction is the moving direction of the upper punch 93, that is, the downward direction. By this compression, the powder compact 2 is manufactured. Here, a protruding portion 93p for forming the recessed portion 23 of the powder compact 2 is formed on the lower face of the upper punch 93. In this example, a recessed portion is formed on the end surface of the protruding portion 93p.

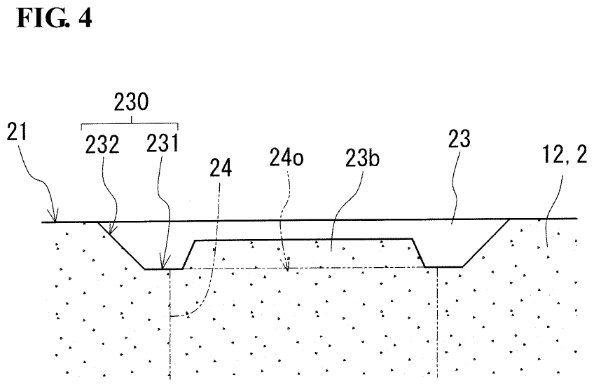

FIG. 4 is a partially enlarged diagram of the vicinity of the recessed portion 23 of the powder compact 2. The recessed portion 23 to which the shape of the protruding portion 93p of the upper punch 93 is transferred is formed on the first surface 21 of the powder compact 2. Since the recessed portion 23 of the present example has the inclined surface 232, when the upper punch 93 is moved upward to take out the powder compact 2 from the mold 9, the upper punch 93 is easily separated from the powder compact 2.

In this example, a thickened portion 23b protruding from the bottom surface 231 is formed at the position of the bottom surface 231 of the recessed portion 23 of the powder compact 2 by the recessed portion formed on the end surface of the protruding portion 93p. By forming the thickened portion 23b, a difference in molding pressure along the compression direction is less likely to occur between the portion having the recessed portion 23 and the portion other than the recessed portion 23 during compacting. Thus, the density of the entirety of the powder compact 2 is likely to be uniform. The protrusion height of the thickened portion 23b from the bottom surface 231 is, for example, 50% to 100% of the depth D of the recessed portion 23. The protrusion height may be 60% or more, 70% or more, or 80% or more of the depth D.

Unlike this example, the protruding portion 93p for forming the recessed portion 23 of the powder compact 2 may be formed in the lower punch 92.

Then, the base hole 24 extending from the bottom surface 231 of the recessed portion 23 is formed by drilling. In FIG. 4, the formation range of the base hole 24 is indicated by a two-dot chain line. The inner diameter of the base hole 24 is smaller than the outer diameter of the self-tapping screw 13. The formation range of the base hole 24 is smaller than the bottom surface 231. Thus, the bottom surface 231 remains so as to annularly surround the opening portion of the base hole 24. When the base hole 24 is formed, the entirety of the thickened portion 23b is removed. Unlike the present example, the base hole 24 may be formed by compacting, but in this case, the density of the powder compact 2 in the vicinity of the base hole 24 is likely to be lower than that of the other portion. When the base hole 24 is formed after the compacting as in this example, the density in the vicinity of the base hole 24 is not significantly reduced as compared with the other portion.

When the base hole 24 is formed by drilling, a burr (not shown) protrudes from an opening portion 24o of the base hole 24. This burr is disposed in the recessed portion 23 and thus does not need to be removed. The burr may be removed, but in this case, care should be taken so that the edge of the opening portion 24o of the base hole 24 is not chipped.

The powder compact 2 may be heat treated before or after drilling. By removing the strain of the powder compact 2 by the heat treatment, the low-loss powder compact 2 can be manufactured. In addition, the binder or the lubricant contained in the powder compact 2 is easily removed by the heat treatment. The temperature of the heat treatment is, for example, 400°c to 900°c.

### Method of Manufacturing Coupled Body

The powder compact 2 manufactured by compacting and the non-powder-compact body 3 prepared separately from the powder compact 2 are stacked as shown in FIG. 1, and the self-tapping screw 13 is inserted from the through-hole 35 of the non-powder-compact body 3 and screwed into the base hole 24 of the powder compact 2. At this time, since the bottom surface 231 is formed on the recessed portion 23, the front end of the shaft portion 13S of the self-tapping screw 13 is not easily inclined with respect to the axis of the base hole 24, and the shaft portion 13S is easily guided straight into the base hole 24.

In the process of screwing the self-tapping screw 13 into the base hole 24, the burr 4 is generated. The burr 4 is disposed in the recessed portion 23, and is not sandwiched between the first member 11 formed of the non-powder-compact body 3 and the second member 12 formed of the powder compact 2. As described above, the coupled body 1 in which the first member 11 and the second member 12 are firmly coupled to each other is manufactured by using the powder compact 2 having the recessed portion 23.

### Embodiment 2

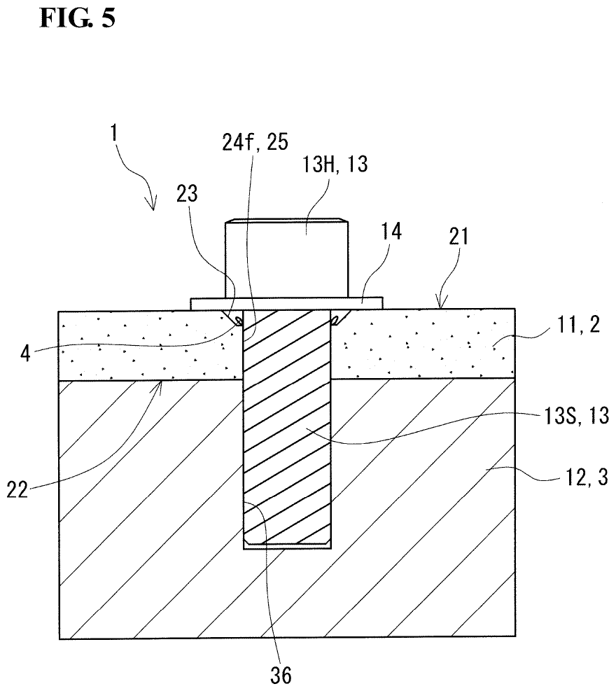

The coupled body 1 according to Embodiment 2 will be described with reference to FIG. 5. In the coupled body 1 of the present example, the first member 11 is the powder compact 2, and the second member 12 is the non-powder-compact body 3.

In this example, the first surface 21 of the powder compact 2 faces the head portion 13H of the self-tapping screw 13. The recessed portion 23 formed on the first surface 21 also faces the head portion 13H. The first hole 25 is a through-hole passing from the first surface 21 to the second surface 22. The internal thread portion 24f is formed on the inner circumferential surface of the first hole 25 over the entire length of the first hole 25. The internal thread portion 24f is formed by the self-tapping screw 13. In the coupled body 1, the burr 4 generated by the self-tapping screw 13 is also disposed in the recessed portion 23. The burr 4 is not sandwiched between the first member 11 made of the powder compact 2 and the head portion 13H, and the head portion 13H firmly applies a uniform pressure to the first surface 21. Thus, the first member 11 and the second member 12 are firmly coupled to each other, and the coupling is not easily loosened.

A screw hole 36 is formed in the second member 12 formed of the non-powder-compact body 3. The self-tapping screw 13 is screw-coupled to the screw hole 36. The screw hole 36 may have an internal thread portion formed by tapping in advance, or may have an internal thread portion formed by the self-tapping screw 13.

### Embodiment 3

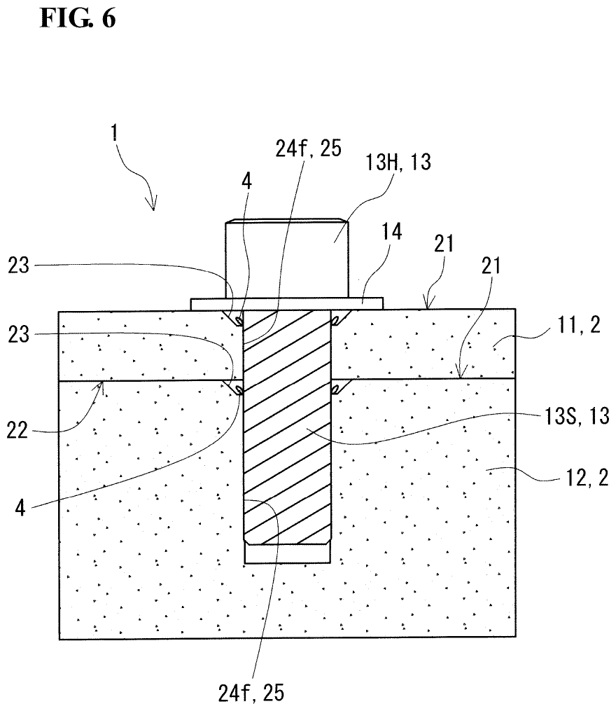

The coupled body 1 according to Embodiment 3 will be described with reference to FIG. 6. In the coupled body 1 of the present example, both the first member 11 and the second member 12 are the powder compact 2.

The first surface 21 and the recessed portion 23 of the powder compact 2, which forms the first member 11, face the head portion 13H of the self-tapping screw 13. The first hole 25 of the first member 11 is a through-hole, and the internal thread portion 24f is formed on the inner circumferential surface of the first hole 25 over the entire length of the first hole 25. The first surface 21 and the recessed portion 23 of the powder compact 2, which forms the second member 12, face the second surface 22 of the first member 11. The first hole 25 of the second member 12 is a blind hole, and the internal thread portion 24f is formed in a part of the inner circumferential surface thereof. The internal thread portion 24f in the first hole 25 of the first member 11 and the second member 12 is formed by the self-tapping screw 13. In the configuration of the present example, the burr 4 generated in each powder compact 2 by the self-tapping screw 13 is disposed in the recessed portion 23 of the powder compact 2 in which the burr 4 is generated. Thus, the first member 11 and the second member 12 are firmly coupled to each other, and the coupling is not easily loosened.

### Embodiment 4

The coupled body 1 according to Embodiment 4 will be described with reference to FIG. 7. In the coupled body 1 of the present example, the first member 11 is the powder compact 2, and the second member 12 is the non-powder-compact body 3. A screw 15 coupling the first member 11 and the second member 12 is not a self-tapping screw. The screw hole 36 of the second member 12 has an internal thread portion formed by tapping a pilot hole. A shaft portion 15S of the screw 15 is screw-coupled to the screw hole 36, so that the first member 11 and the second member 12 are coupled to each other.

The first member 11 facing a head portion 15H of the screw 15 is the powder compact 2. The inner diameter of the first hole 25 of the powder compact 2 is a through-hole larger than the outer diameter of the shaft portion 15S of the screw 15. No internal thread portion is formed on the inner circumferential surface of the first hole 25. The first hole 25 is the base hole 24 itself formed by drilling when the powder compact 2 is manufactured. The burr 4 disposed in the recessed portion 23 is generated during drilling.

The coupled body 1 of the present example is manufactured by coupling the powder compact 2 and the non-powder-compact body 3 without removing the burr 4 generated when the base hole 24 is formed in the powder compact 2. The productivity of the coupled body 1 is increased by the amount of the burr 4 that does not need to be removed.

### Embodiment 5

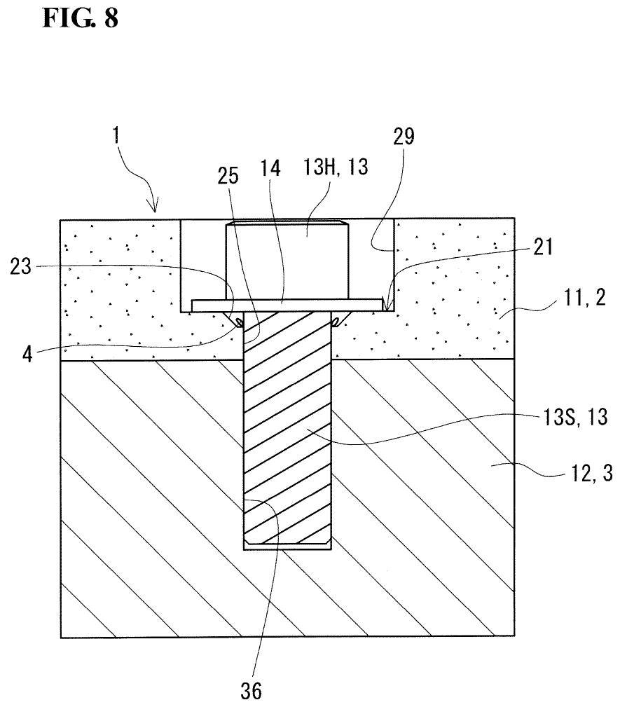

As a modification of embodiment 2 referring to FIG. 5, the coupled body 1 according to embodiment 5 in which the powder compact 2 includes a housing portion 29 will be described with reference to FIG. 8. In the coupled body 1 of the present example, the first member 11 is the powder compact 2, and the second member 12 is the non-powder-compact body 3.

The powder compact 2, which forms the first member 11, has the housing portion 29 in which entirety of the head portion 13H of the self-tapping screw 13 is housed. In this case, the bottom surface of the housing portion 29 becomes the first surface 21. In the coupled body 1 of the present example, the burr 4 generated by the self-tapping screw 13 is also disposed in the recessed portion 23.

### Embodiment 6

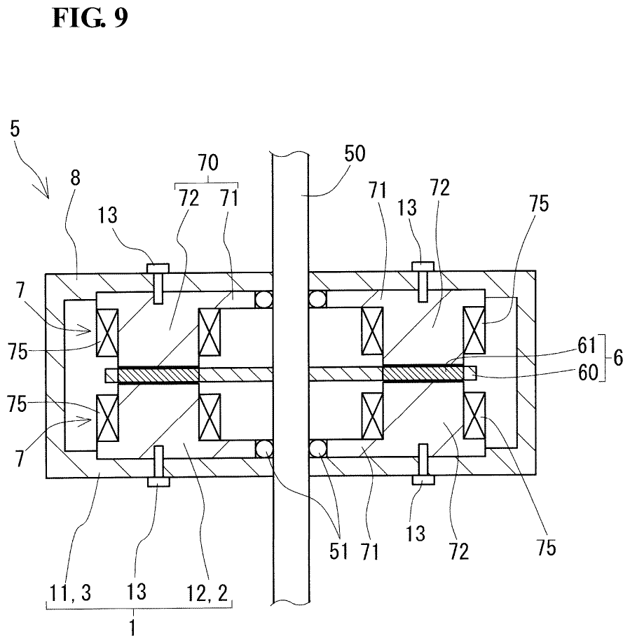

In embodiment 6, an example in which the configuration of the coupled body 1 shown in embodiment 1 is applied to a rotating electrical machine 5 will be described with reference to FIG. 9. The rotating electrical machine 5 may be a generator or an electric motor.

The rotating electrical machine 5 of the present example includes a rotor 6, a stator 7, and a case 8. The rotating electrical machine 5 of the present example is an axial gap type rotating electrical machine 5 in which the rotor 6 and the stator 7 are arranged in a direction along the rotation axis of the rotor 6.

### Rotor

The rotor 6 includes a plurality of flat plate-shaped magnets 61 and an annular holding plate 60 that supports the magnets 61. The holding plate 60 is fixed to a shaft 50 and rotates together with the shaft 50. The magnets 61 are embedded in the holding plate 60. The magnets 61 are spaced around the shaft 50. The magnets 61 are magnetized in a direction along the shaft 50. The magnetization directions of the magnets 61 adjacent to each other in the rotation direction of the shaft 50 are opposite to each other.

### Stator

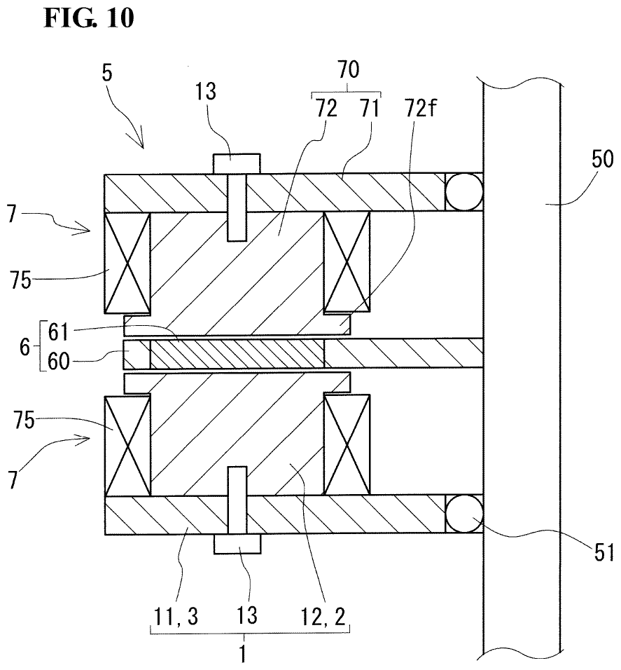

The stator 7 includes a core 70 and a plurality of coils 75. The core 70 includes a yoke 71 having an annular shape and a plurality of teeth 72. The tooth 72 may have a pole shoe 72f (FIG. 10) as shown in Embodiment 7 described later. The plurality of teeth 72 protrude from one face of the yoke 71. The coils 75 are disposed in each tooth 72. The rotating electrical machine 5 of the present example includes the two stators 7. The end surface of the tooth 72 of the first stator 7 and the end surface of the tooth 72 of the second stator 7 face each other with the rotor 6 interposed therebetween. The core 70 of the present example is formed of the powder compact 2.

### Case

The case 8 houses the rotor 6 and the stator 7. The case 8 is, for example, a nonmagnetic body. The nonmagnetic material is, for example, an aluminum alloy. The shaft 50 connected to the rotor 6 passes through the case 8. A bearing 51 is disposed between the outer peripheral face of the shaft 50 and the case 8.

In the rotating electrical machine 5 of the present example, the core 70 formed of the powder compact 2 and the case 8 formed of the non-powder-compact body 3 are coupled by the self-tapping screw 13. The burr 4 (FIG. 1) generated by the self-tapping screw 13 is not interposed between the core 70 and the case 8. Thus, the core 70 is firmly fixed to the case 8, and the rotation of the rotor 6 is stabilized.

The rotating electrical machine 5 of this example is a single rotor double stator type rotating electrical machine. The rotating electrical machine 5 to which the configuration of the coupled body 1 is applied may be a rotating electrical machine of another type such as a double-rotor single-stator type rotating electrical machine.

### Embodiment 7

In embodiment 7, the rotating electrical machine 5 including the coupled body 1 different from that of embodiment 6 will be described with reference to FIG. 10. In FIG. 10, only the left half of the rotating electrical machine 5 is shown, and the case is not shown.

The tooth 72 of the core 70 of the present example includes the pole shoe 72f. The pole shoe 72f extends laterally from the position of the end of the tooth 72 on the side face of the tooth 72. The pole shoe 72f improves the magnetic properties of the rotating electrical machine 5.

In the core 70 of the present example, the yoke 71 and the tooth 72 are independently manufactured. The yoke 71 and the tooth 72 are coupled by the self-tapping screw 13, thereby forming the coupled body 1 of the embodiment 7. In this case, the yoke 71 is the first member 11, and the tooth 72 is the second member 12.

The yoke 71 of the present example is the non-powder-compact body 3, and the tooth 72 is the powder compact 2. The non-powder-compact body 3 is, for example, a SS400 plate, a SUS plate, or a laminated steel sheet. Unlike the present example, both the yoke 71 and the tooth 72 may be the powder compact 2, or the yoke 71 may be the powder compact 2 and the tooth 72 may be the non-powder-compact body 3.

### Embodiment 8

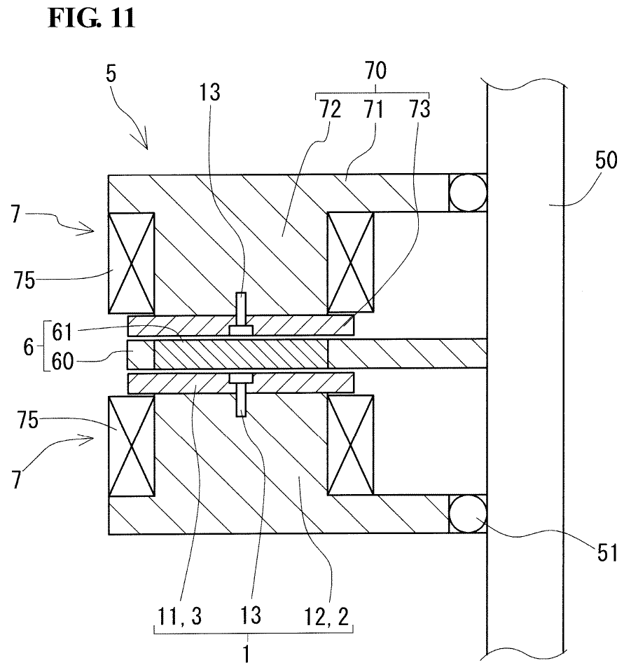

In embodiment 8, the rotating electrical machine 5 including the coupled body 1 different from those in embodiments 6 and 7 will be described with reference to FIG. 11. In FIG. 11, only the left half of the rotating electrical machine 5 is shown, and the case is not shown.

The core 70 of the present example includes the yoke 71 and the tooth 72 integrated with each other, and further includes a pole shoe member 73 disposed on an end surface of the tooth 72. The pole shoe member 73 is a plate-like member and has the functions of the end of the tooth 72 and the pole shoe 72f in FIG. 10 of embodiment 7.

In the core 70 of the present example, the tooth 72 and the pole shoe member 73 are independently manufactured. The tooth 72 and the pole shoe member 73 are coupled by the self-tapping screw 13, thereby forming the coupled body 1 of the embodiment 8. In this case, the pole shoe member 73 is the first member 11, and the tooth 72 is the second member 12.

In embodiment 8, the yoke 71 and the tooth 72 may be independent members. In this case, as in the configuration of embodiment 7, the yoke 71 and the tooth 72 may be coupled by the self-tapping screw 13.

### Appendix

Configurations of the coupled body in the present disclosure are applicable to coupling of an injection-molded article. That is, a coupled body according to an appendix includes a first member, a second member disposed in contact with the first member, and a screw configured to couple the first member and the second member to each other by passing through the first member and reaching the second member, in which at least one of the first member and the second member is an injection-molded article. The injection-molded article has a first surface facing the first member in contact with the injection-molded article or facing a head portion of the screw, a recessed portion formed on the first surface, and a first hole extending from the recessed portion and in which a shaft portion of the screw is disposed. The opening area of the recessed portion is larger than the opening area of the first hole, and an inner circumferential surface of the recessed portion has no machining mark.

The injection-molded article is, for example, a composite material containing a resin and powder or a resin molded body. In the composite material, the powder is dispersed in the resin. The powder is, for example, soft magnetic powder. With the configurations in the appendix, a burr protruding at an opening portion of the first hole can be disposed inside the recessed portion when the first member and the second member are coupled to each other, and the first member and the second member can be coupled to each other firmly.

What is claimed is:

1. A coupled body comprising:
a first member;
a second member disposed in contact with the first member; and
a screw configured to couple the first member and the second member to each other by passing through the first member and reaching the second member,
wherein at least one of the first member and the second member is a powder compact,
wherein the powder compact has
a first surface facing the first member in contact with the powder compact or facing a head portion of the screw,
a recessed portion formed on the first surface, and
a first hole extending from the recessed portion and in which a shaft portion of the screw is disposed,
wherein an opening area of the recessed portion is larger than an opening area of the first hole, and
wherein an inner circumferential surface of the recessed portion has no machining mark.

2. The coupled body according to claim 1,
wherein the second member is the powder compact, and
wherein a surface of the second member facing the first member is the first surface.

3. The coupled body according to claim 1,
wherein the screw is a self-tapping screw.

4. The coupled body according to claim 3,
wherein relative density of the powder compact is 85% or more.

5. The coupled body according to claim 4,
wherein the powder compact contains soft magnetic powder,
wherein the soft magnetic powder is an aggregate of soft magnetic particles each having insulation coating on a surface thereof, and
wherein the soft magnetic particles are made of at least one material selected from the group consisting of pure iron, an Fe—Si—Al-based alloy, an Fe—Si-based alloy, an Fe—Al-based alloy, and an Fe—Ni-based alloy.

6. The coupled body according to claim 1,
wherein the inner circumferential surface of the recessed portion includes an inclined surface connected to the first surface, and
wherein an angle formed by the first surface and an extension surface is less than 90 degrees, the extension surface being an extension of the inclined surface extended further outward than the first surface.

7. The coupled body according to claim 1,
wherein the recessed portion has a depth of 0.1 mm to 3.0 mm.

8. The coupled body according to claim 1,
wherein the inner circumferential surface of the recessed portion includes a bottom surface parallel to the first surface.

9. The coupled body according to claim 1,
wherein the second member is a core of a stator of a rotating electrical machine,
wherein the first member is a case configured to house the stator, and
wherein the core is formed by the powder compact.

10. The coupled body according to claim 1,
wherein the second member is a tooth included in a core of a stator of a rotating electrical machine,
wherein the first member is a yoke included in the core, and
wherein the tooth is formed by the powder compact.

11. The coupled body according to claim 1,
wherein the second member is a tooth included in a core of a stator of a rotating electrical machine,
wherein the first member is a pole shoe member disposed at an end surface of the tooth, and
wherein the tooth is formed by the powder compact.

12. A powder compact configured to be coupled to another member by a screw, the powder compact comprising:
a first surface configured to face the another member or a head portion of the screw in a state in which the powder compact is coupled to the another member, and
a recessed portion formed on the first surface,
wherein the powder compact has a base hole extending from the recessed portion and configured such that a shaft portion of the screw is disposed in the base hole in a state in which the powder compact is coupled to the another member,
wherein an opening area of the recessed portion is larger than an opening area of the base hole, and
wherein an inner circumferential surface of the recessed portion has no machining mark.

13. A method of manufacturing a powder compact, the method comprising:
forming the recessed portion of the powder compact according to claim 12 by compacting by which the powder compact is manufactured.

14. The method of manufacturing a powder compact according to claim 13, the method comprising:
forming the base hole by drilling after the compacting.

15. The method of manufacturing a powder compact according to claim 14, the method comprising:
forming a thickened portion protruding from a bottom surface of the recessed portion by the compacting; and
removing an entirety of the thickened portion by the drilling.
